(19) United States
(12) Patent Application Publication
(10) Pub. No.: US 2023/0154501 A1
(43) Pub. Date: May 18, 2023

(54) REDUCED THICKNESS COMPONENTS FOR HARD DISK DRIVES

(71) Applicant: Seagate Technology LLC, Fremont, CA (US)

(72) Inventors: Xiong Liu, Singapore (SG); Lihong Zhang, Singapore (SG)

(21) Appl. No.: 17/526,448

(22) Filed: Nov. 15, 2021

(51) Int. Cl. G11B 33/02

(52) U.S. Cl. CPC G11B 33/027

(57) ABSTRACT

A hard disk drive includes a base and a cover coupled together to create an enclosure and an actuator assembly positioned in the enclosure. The actuator assembly includes a body and arms extending from the body, and the arms comprise a reinforced aluminum alloy. Magnetic recording disks are respectively positioned between pairs of the arms.

### SUMMARY

In certain embodiments, a hard disk drive includes a base and a cover coupled together to create an enclosure and an actuator assembly positioned in the enclosure. The actuator assembly includes a body and arms extending from the body, and the arms comprise a reinforced aluminum alloy. Magnetic recording disks are respectively positioned between pairs of the arms.

In certain embodiments, a hard disk drive includes a base and a cover coupled together to create an enclosure and an actuator assembly positioned in the enclosure. The actuator assembly includes a body and arms extending from the body. The body and the arms comprises a carbon-reinforced material, and the arms each having a thickness of 0.58-0.71 mm.

In certain embodiments, a hard disk drive includes a base and a cover coupled together to create an enclosure and an actuator assembly positioned in the enclosure. The actuator assembly includes a body and eleven or twelve arms extending from the body. The arms have a thickness of 0.58-0.71 mm and comprise a reinforced aluminum alloy. The hard disk drive further includes ten or eleven magnetic recording disks each of which is positioned between one pair of the arms.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 shows a perspective exploded view of a hard disk drive, in accordance with certain embodiments of the present disclosure.

FIG. 2 shows a side view of certain components of the hard disk drive of FIG. 1, in accordance with certain embodiments of the present disclosure.

FIG. 3 shows a close-up view of a portion of FIG. 2, in accordance with certain embodiments of the present disclosure.

FIG. 4 shows a simplified schematic of a side view of a hard disk drive, in accordance with certain embodiments of the present disclosure.

While the disclosure is amenable to various modifications and alternative forms, specific embodiments have been shown by way of example in the drawings and are described in detail below. The intention, however, is not to limit the disclosure to the particular embodiments described but instead is intended to cover all modifications, equivalents, and alternatives falling within the scope of the appended claims.

### DETAILED DESCRIPTION

One approach for increasing the data storage capacity of hard disk drives is to fit one or more additional disks (and related components such as read/write heads) into standard-size enclosures of the hard disk drives. Adding one or more disks into a standard-height 3.5″ form factor hard disk drive can be challenging to accomplish given space constraints and performance constraints. Certain embodiments of the present disclosure are directed to approaches for making more space available for disks within enclosures of hard disk drives.

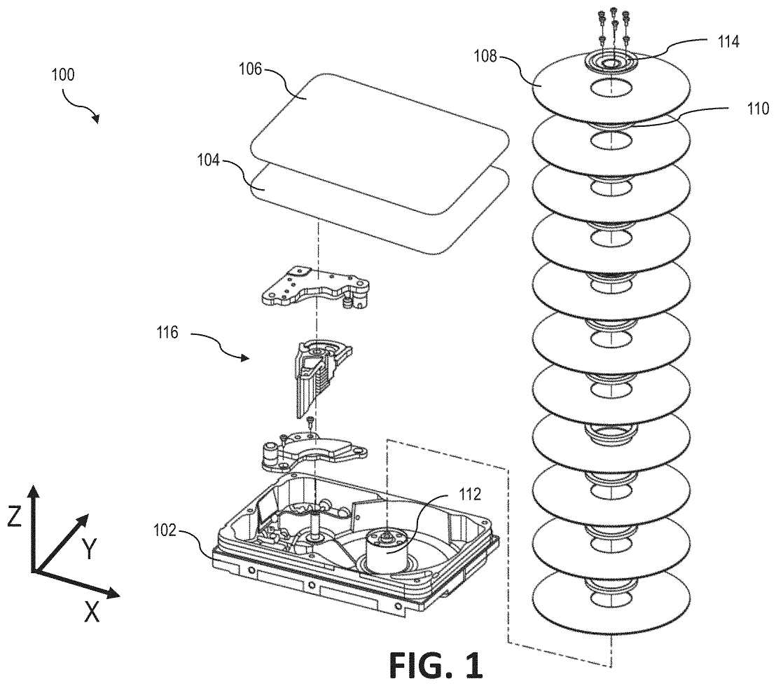

FIG. 1 shows an exploded view of a hard disk drive 100, which can include a base deck 102 (sometimes referred to as a baseplate), a process cover 104, and a top cover 106. The process cover 104 can be coupled to the base deck 102 to create an internal cavity that houses data storage components like magnetic recording media 108 (eleven of which are shown in FIG. 1 and which are sometimes referred to herein as disks), disk spacers 110 (ten of which are shown in FIG. 1) positioned between adjacent magnetic recording media 108, a spindle motor 112, a disk clamp 114, and an actuator assembly 116. Although eleven individual disks are shown in FIG. 1, the hard disk drive 100 could include a different number of disks. As just an example, the hard disk drive 100 could include ten disks or twelve disks.

During assembly, the process cover 104 can be coupled to the base deck 102 by removable fasteners to seal a target gas (e.g., air with nitrogen and oxygen and/or a lower-density gas like helium) within the internal cavity. Once the process cover 104 is coupled to the base deck 102, a target gas may be injected into the internal cavity through an aperture in the process cover 104. Injecting the target gas, such as a combination of air and a low-density gas like helium (e.g., with the target gas including 90 percent or greater helium), may involve first evacuating existing gas from the internal cavity and then injecting the target gas from a low-density gas supply reservoir into the internal cavity.

Once the process cover 104 is sealed and the target gas injected, the hard disk drive 100 can be subjected to a variety of processes and tests. Example processes and tests include those that establish performance parameters of the hard disk drive 100 (e.g., fly-height parameters), that identify and map flaws on the magnetic recording media, that write servo and data patterns on the magnetic recording media, and that determine whether the hard disk drive 100 is suitable for commercial sale. Once the hard disk drive 100 has passed certain processes and tests, the base deck 102 and the top cover 106 can be coupled together by welding. In embodiments where air—instead of helium—is the target gas, the hard disk drive 100 may only have a top cover and it may be coupled to the base deck with fasteners and a sealing gasket.

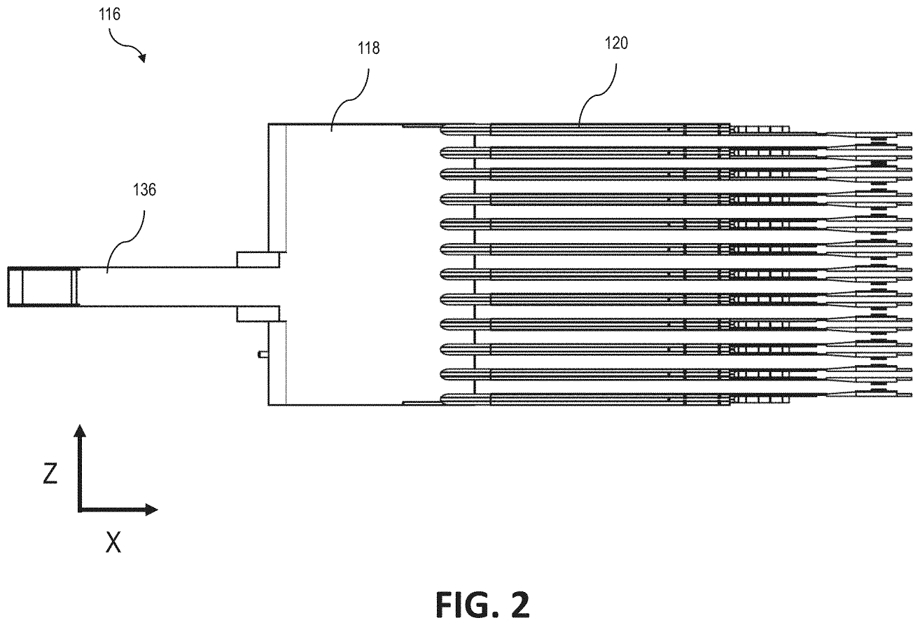

FIG. 2 shows a side view of the actuator assembly 116. The actuator assembly 116 includes a body 118 and arms 120 (twelve of which are shown in FIG. 2) that extend from the body 118 like cantilevers. Because of its shape, the body 118 and arms 120 of the actuator assembly 116 are sometimes referred to as an “e-block.” The body 118 and the arms 120 can be formed from the same piece of metal such that body 118 and the arms 120 are not separate parts assembled to each other but instead are integral.

An actuator assembly with twelve arms can accommodate eleven disks. As such, if more disks or fewer disks than eleven disks are used, the number of arms can be increased or decreased as needed.

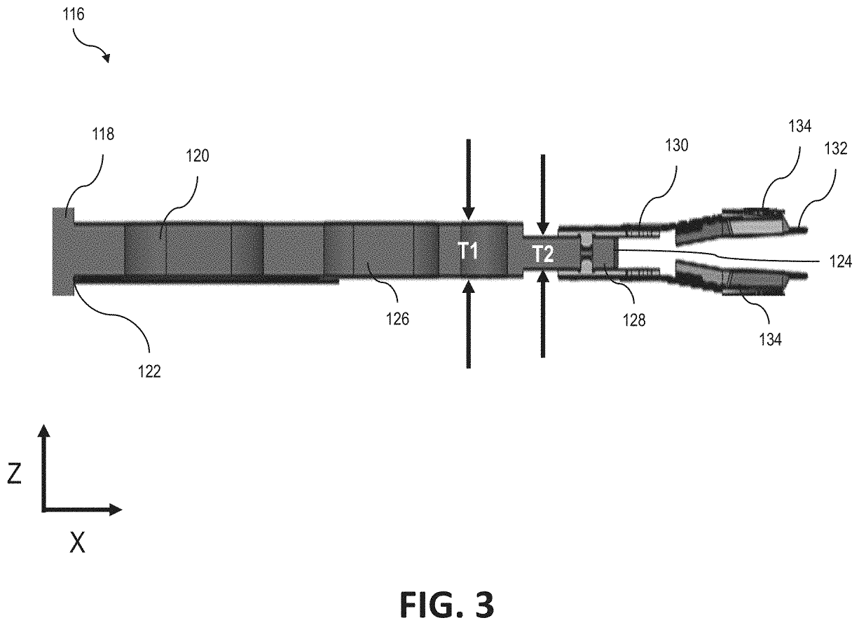

FIG. 3 shows a closer-up view of a portion of the actuator assembly 116. The arms 120 have a proximal end 122 that begins where the body 118 ends. The arms 120 extend from the body 118 (at the proximal end 122) to a distal end 124 of the arms 120. The section of the arms 120 nearest to the body 118 can be referred to a root portion 126 (or first portion or base portion), and the section of the arms 120 nearest to the distal end 124 can be referred to a tip portion 128 (or second portion or end portion). As can be seen in FIG. 3, the root portion 126 is thicker than the tip portion 128, where thickness is the distance between a lowermost surface to an uppermost surface (e.g., bottom to top, z-direction).

As will be described in more detail below, thicker components have more rigidity compared to thinner components, if all other things are held constant. However, thicker components consume more space within the hard disk drive 100. In the example of FIG. 3, the thinner tip portion 128 can begin where the additional space contributes to providing more space for additional disks. However, in certain embodiments, the arms 120 have a approximately uniform thickness between the proximal end 122 and the distal end 124.

The tip portion 128 is coupled (e.g., directly coupled) to two suspension assemblies 130. The suspension assemblies 130 include what are sometimes referred to as head-gimbal assemblies or HGAs. The suspension assemblies 130 can also include lift tabs 132 at the distal end of the suspension assemblies 130 (and actuator assembly 116). The suspension assemblies 130 also include read/write heads 134 (or sliders), which include a write transducer for writing data (e.g., via positive and negative magnetic transitions) to the magnetic recording media and a read transducer for reading or sensing data written to the magnetic recording media. Although the arm 120 shown in FIG. 3 is coupled to two suspensions, arms on the ends (e.g., lower end and upper end) of the actuator assembly 116 may be coupled to only one suspension. In certain embodiments, the outer arms are slightly thinner (e.g., 10% thinner) than the arms between the outer arms.

Referring back to FIG. 2, the actuator assembly 116 also includes a shelf 136 that is shaped to secure a coil (e.g., conductive coil). During operation of the hard disk drive 100, a current is varied and applied to the coil to generate magnetic fields, which interact with permanent magnets, which are part of the voice coil motor. This controlled interaction among magnetic fields helps rotate the actuator 116 to position the read/write heads 134 over a desired part of the magnetic recording media 108.

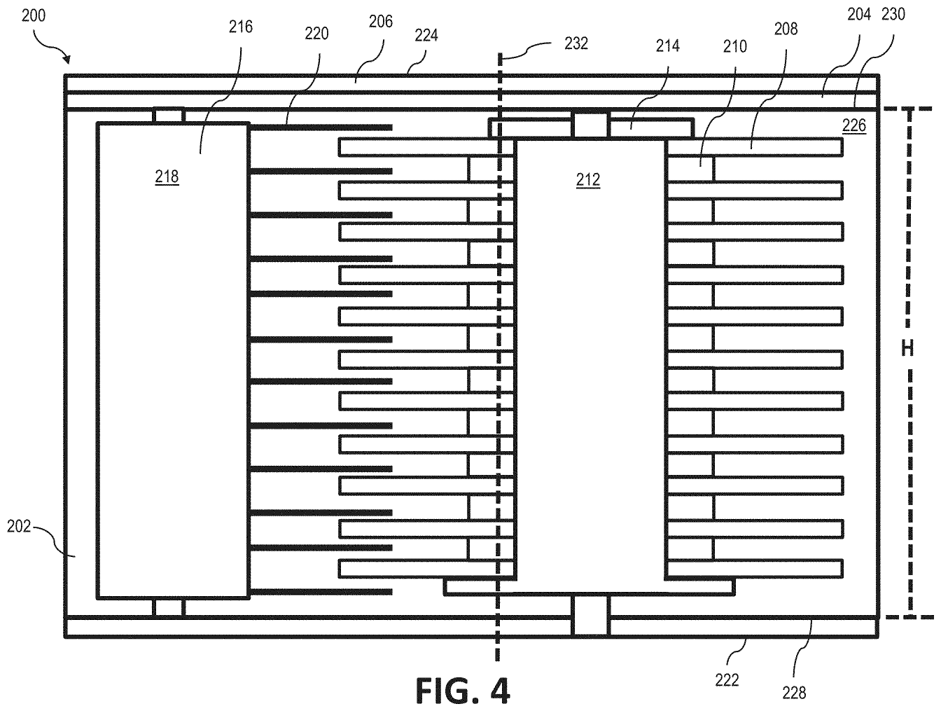

To help explain certain space constraints of hard disk drives such as the hard disk drive 100 of FIG. 1, FIG. 4 shows a simplified schematic of a hard disk drive 200. It is noted that the features and dimensions of the hard disk drive 200 of FIG. 4 described below could be used with the hard disk drive 100 of FIG. 1. The relative dimensions of the components shown in FIG. 4 are not necessarily to scale.

The hard disk drive 200 includes a base deck 202, a process cover 204, a top cover 206, magnetic recording media 208, disk spacers 210, a spindle motor 212, disk clamp 214, and an actuator assembly 216. For illustrative purposes, the hard disk drive 200 can be a 3.5″ form factor hard disk drive, which can be at least partially filled with air and/or a low density gas such as helium. The tallest standard-sized 3.5″ form factor hard disk drives have an overall external height of 26.1 mm or less (e.g., 25 mm to 26.1 mm), as measured from a bottom-most external surface 222 to a topmost external surface 224 of the hard disk drive 200. Although eleven individual disks are shown in FIG. 4, the hard disk drive 200 could include a different number of disks. As just an example, the hard disk drive 200 could include ten disks or twelve disks.

The base deck 202 and the process cover 204 form an enclosure with an internal cavity 226. Although the height (H) of the internal cavity 226 is shown as being uniform in FIG. 4, the height H can vary depending on the topology of internal surfaces of the base deck 202 (see e.g., the base deck 102 shown in FIG. 1) and the process cover 204 (or the top cover 206 in embodiments without a process cover). For example, the height H extends between a top surface 228 of the base deck 202 and a bottom surface 230 of the process cover 204 but the surface profile (or topology) varies along these surfaces. As such, the height H of the internal cavity 226 at one point in the enclosure may be different compared to the height H at another part of the enclosure.

The space within the internal cavity 226 along the height H can be consumed by the magnetic recording media 208, the disk spacers 210, parts of the spindle motor 212, the disk clamp 214, and parts of the actuator assembly 216. For example, along a plane 232 (represented by dashed line 232 in FIG. 4), each of the components listed above consume space within the height H. Therefore, the thicknesses of these components can affect the number of disks of the magnetic recording media 208 that can fit within the internal cavity 226. In addition to changing the thickness of the components within the internal cavity 226, the height H itself of the internal cavity 226 can change if the thickness of the base deck 202 changes. For example, a thinner base deck 202 will increase the height H of the internal cavity 226. Further, reducing the thickness of the process cover 204 and the top cover 206 can increase the space available for the magnetic recording media 208.

As such, to increase the space available to fit more magnetic recording media 208, the thicknesses of the various components can be decreased. However, as the thickness of the various components and the base deck 202 is decreased, the structural rigidity is reduced—holding other things constant such as the width of components. A component with less rigitidy is more susceptible to deformation, which can lead to performance problems. As an example, if the arms 220 of the actuator assembly 216 have less rigidity, the arms will—when subjected to a given force (e.g., a shock event)—deform/deflect more (compared to arms with greater rigitidy). This deformation can lead the read/write head to be more likely to contact the magnetic recording media 208 and cause damage.

However, the negative effect of reducing the thickness can be at least partially offset by using materials with a comparatively higher modulus of elasticity (sometimes referred to as Young's Modulus). Accordingly, certain embodiments of the present disclosure feature components that comprise materials with a higher modulus of elasticity than aluminum. As such, the components can be thinner while maintaining or increasing the rigidity of the components. Incorporating thinner components in hard disk drives can create additional space for additional magnetic recording media. In embodiments with one or more components comprising reinforced aluminum alloys, hard disk drives of a 3.5″ form factor and with an overall height that is 26.1 mm can accomodate 10, 11, or 12 disks. It is appreciated that the approaches described herein can be used in different form factors (e.g., 2.5″ form factors) and different heights for accommodating different numbers of disks in the given form factors.

In certain embodiments, one or more of the following components can comprise a material with an aluminum alloy and a reinforcement material: magnetic recording media (e.g., the substrates of the media), disk spacers, spindle motors, disk clamps, actuator assemblies, process covers, and top covers. In certain embodiments, the entire component comprises the aluminum alloy and reinforcement material (e.g., the reinforced material is not just a coating or exterior layer). In certain embodiments, the reinforcement materials comprise a carbon-based material, a ceramic material, boron nitride, beryllium oxide, or aluminum oxide.

Examples of carbon-reinforced aluminum alloys include aluminum alloys comprising graphene or carbon nanotubes (e.g., single-wall carbon nanotubes or multi-wall carbon nanotubes). The graphene or carbon nanotubes can mixed (e.g., suspended) with an aluminum alloy as the alloy is manufactured to create the carbon-reinforced aluminum alloy.

Aluminum alloys (without carbon-reinforcement) typically have a modulus of elasticity of 65-70 gigapascals (GPas). Graphene itself typically has a modulus of elasticity of ˜1000 GPas, and carbon nanotubes themselves typically have a modulus of elasticity range of 1000-2000 GPas. Carbon-reinforced aluminum alloys (such as aluminum alloys comprising 0.5-2% weight of carbon nanotubes or graphene) can have a modulus of elasticity range of 85-105 GPas. As such, carbon-reinforced aluminum alloys can have a modulus of elasticity that is 20% to 60% higher than aluminum alloys without carbon reinforcement. As the weight percentage of the reinforcing carbon-based material is increased, the modulus of elasticity is also increased.

As noted above, other reinforcing materials can include boron nitride, beryllium oxide, aluminum oxide (e.g., Al₂O₃), and ceramic materials. In general, the modulus of elasticity of these reinforced aluminum alloys are 10-30% greater compared to non-reinforced materials by incorporating 5-20% volume of the reinforcing materials.

Therefore, using reinforced aluminum alloys (as opposed to non-reinforced alloys), the thickness of the various components listed above can be reduced with limited to no decreases in their respective rigidity. As a result of using reinforced aluminum alloys (and therefore thinner components), the space available for additional magnetic recording media is increased. Further, in addition to a higher modulus of elasticity, the reinforced materials can have higher hardness, bending strength, and tensile strength compared to non-reinforced materials.

In certain embodiments, using reinforced aluminum alloys, the thickness of arms (e.g., the arms 120/220) of an actuator assembly can be 0.023″ (0.58 mm) to 0.028″ (0.71 mm) with limited to no reduction in rigidity compared to thicker non-reinforced aluminum alloy arms. In certain embodiments, the thickness is measured in the Z-direction at a point along the tip portion 128 (see e.g., T2 shown in FIG. 3) of the arms. To accommodate for the suspensions coupled to the tip portion 128, the tip portion 128 may be thinner than the root portion 126.

In certain embodiments, using reinforced aluminum alloys, the thickness of disk spacers (e.g., the disk spacers 110/210) positioned between the magnetic recording media can be 0.042″ (1 mm) to 0.060″ (1.5 mm) with limited to no reduction in rigidity compared to thicker non-reinforced aluminum alloy disk spacers.

Because of the number of arms of an actuator assembly and the number of disk spacers, reducing the thickness of each arm and disk spacer has a greater overall contribution to increasing the space available for magnetic recording media compared to reducing the thickness of components such as the disk clamp—for which there is only one within a hard disk drive.

As one example, arms with a thickness of ˜0.0297″ (0.75 mm) are approximately 10% thinner than arms for 9-disk hard disk drives, and this 10% reduction in thickness of the arms can create enough additional space for one more disk in a 3.5″ form factor hard disk drive that has an overall height of 26.1 mm. In such examples, given the cantilevered arrangement of the arms, the modulus of elasticity should be at least 20% greater compared to that of the thicker arms with non-reinforced aluminum alloys. With such an increase in the modulus of elasticity combined with a decrease in thickness of the arms, the arms can at least maintain the amount of deflection experienced by the arms under a given force—compared to thicker arms without a reinforced aluminum alloy.

As another example, arms with a thickness of ˜0.0264″ (0.671 mm) are approximately 20% thinner than arms for 9-disk hard disk drives, and this 20% reduction in thickness can create enough additional space for two more disks in a 3.5″ form factor hard disk drive that has an overall height of 26.1 mm. In such examples, given the cantilevered arrangement of the arms, the modulus of elasticity should be at least 40% greater compared to that of the thicker arms with non-reinforced aluminum alloys. With such an increase in the modulus of elasticity combined with a decrease in thickness of the arms, the arms can at least maintain the amount of deflection experienced by the arms under a given force—compared to thicker arms without a reinforced aluminum alloy.

Reducing thickness of components other than the arms will also contribute to increasing the space available for additional magnetic recording media. In certain embodiments, using reinforced aluminum alloys, the thickness of disk clamps (e.g., the disk clamp 114/214) used to coupled magnetic recording media to the spindle motor can be 0.038″ (0.97 mm) to 0.046″ (1.16 mm) with limited to no reduction in rigidity compared to thicker non-reinforced aluminum alloy disk clamps.

In certain embodiments, using reinforced aluminum alloys, the thickness of substrates of magnetic recording media (e.g., the magnetic recording media 108/208) can be 0.017″ (0.44 mm) to 0.021″ (0.54 mm) with limited to no reduction in rigidity compared to thicker non-reinforced aluminum alloy substrates. Substrates of the magnetic recording media contribute the most to the overall thickness of the magnetic recording media because the layers deposited on the substrate are typically on the order of micrometers thick. In some embodiments, instead of reinforced aluminum alloys, the substrates comprise glass and have a thickness of 0.018″ (0.45 mm) to 0.020″ (0.51 mm).

In certain embodiments, using reinforced aluminum alloys, the thickness of base decks (e.g., the base deck 102/202) adjacent to the bottommost disk can be 0.070″ (1.78 mm) to 0.094″ (2.4 mm) with limited to no reduction in rigidity compared to thicker non-reinforced aluminum alloy base decks.

In certain embodiments, using reinforced aluminum alloys, the thickness of top covers (e.g., the top cover 106/206) welded to the base deck can be 0.010″ (0.25 mm) to 0.016″ (0.40 mm) with limited to no reduction in rigidity compared to thicker non-reinforced aluminum alloy top covers.

Various modifications and additions can be made to the embodiments disclosed without departing from the scope of this disclosure. For example, while the embodiments described above refer to particular features, the scope of this disclosure also includes embodiments having different combinations of features and embodiments that do not include all of the described features. Accordingly, the scope of the present disclosure is intended to include all such alternatives, modifications, and variations as falling within the scope of the claims, together with all equivalents thereof.

1. A hard disk drive comprising:
a base;
a top cover coupled to the base;
a process cover coupled to the base to create an enclosure and positioned between the base and the top cover; and
an actuator assembly positioned in the enclosure and including a body and only 12 arms extending from the body, the body and the arms comprising a carbon-reinforced material, the arms each having a thickness of 0.58-0.71 mm,
wherein the hard disk drive is a 3.5″ form factor hard disk drive having an overall external height of 25-26.1 mm and that is filled with a target gas comprising helium.

2. The hard disk drive of claim 1, wherein the arms each include a root portion and a tip portion, wherein the thickness is measured at a point on the tip portion, wherein the root portion is positioned between the body and the tip portion.

3. The hard disk drive of claim 2, wherein the tip portion is thinner than the root portion.

4. (canceled)

5. The hard disk drive of claim 1, further comprising only 11 disks each of which extends between a separate pair of the arms.

6.-9. (canceled)

10. The hard disk drive of claim 1, wherein the carbon-reinforced material is an aluminum alloy comprising 0.5-2% weight of carbon nanotubes.

11. A hard disk drive comprising:
a base;
a top cover coupled to the base;
a process cover coupled to the base to create an enclosure and positioned between the base and the top cover;
an actuator assembly positioned in the enclosure and including a body and only 11 arms extending from the body, the arms comprising a reinforced aluminum alloy, the arms each having a thickness of 0.58-0.71 mm; and
only 10 magnetic recording disks each of which is positioned between one pair of the arms,
wherein the hard disk drive is a 3.5″ form factor hard disk drive having an overall external height of 25-26.1 mm and that is filled with a target gas comprising helium.

12. The hard disk drive of claim 11, wherein the reinforced aluminum alloy has a modulus of elasticity of 85-105 GPas.

13. The hard disk drive of claim 11, wherein the reinforced aluminum alloy comprises carbon nanotubes.

14. (canceled)

15. The hard disk drive of claim 11, wherein the arms include two outer arms, wherein the outer arms are thinner than the other arms.

16. The hard disk drive of claim 11, further comprising a disk clamp comprising a reinforced aluminum alloy.

17. The hard disk drive of claim 11, wherein the base comprises a reinforced aluminum alloy.

18. The hard disk drive of claim 11, wherein the magnetic recording disks each include a substrate, wherein the substrates comprise a reinforced aluminum alloy.

19. (canceled)

20. (canceled)

21. The hard disk drive of claim 1, wherein the reinforced aluminum alloy has a modulus of elasticity of 85-105 GPas.

22. The hard disk drive of claim 1, wherein the carbon-reinforced material is an aluminum alloy comprising 0.5-2% weight of graphene.

23. The hard disk drive of claim 1, wherein the hard disk drive has an overall external height of 26.1 mm.

24. The hard disk drive of claim 1, wherein the body and the arms are integrally formed and not separate pieces assembled to each other.

25. The hard disk drive of claim 11, wherein the carbon-reinforced material is an aluminum alloy comprising 0.5-2% weight of graphene.

26. The hard disk drive of claim 11, wherein the hard disk drive has an overall external height of 26.1 mm.

27. The hard disk drive of claim 11, wherein the body and the arms are integrally formed and not separate pieces assembled to each other.
